(19) United States
(12) Patent Application Publication
(10) Pub. No.: US 2022/0279796 A1
(43) Pub. Date: Sep. 8, 2022

(54) CONTROL OF GREEN MACROALGAE BLOOMS

(71) Applicant: ALGAR HOLDING LTD, Manchester (GB)

(72) Inventors: Elvenn LORET, Marseille (FR); Patrick RAMBAUD, Mandelieu La Napoule (FR)

(73) Assignee: ALGAR HOLDING LTD, Manchester (GB)

(21) Appl. No.: 17/634,782

(22) PCT Filed: Aug. 14, 2020
(86) PCT No.: PCT/EP2020/072931

§ 371 Date: Feb. 11, 2022

Related U.S. Application Data
(60) Provisional application No. 62/886,424, filed on Aug. 14, 2019.

(30) Foreign Application Priority Data
Aug. 14, 2019 (FR) FR1909208

(51) Int. Cl. A01N 63/40; A01N 25/04; A01P 13/00

(52) U.S. Cl. CPC A01N 63/40; A01N 25/04; A01P 13/00

(57) ABSTRACT

The control of green macroalgae blooms. More particularly, Ulva algae blooms may be controlled by a living active principle contained in seawater from the Mediterranean Sea. The inventors have observed that seawater from the Mediterranean Sea collected in particular spots (collected at, e.g., latitude 43° 14′N and longitude 5° 21′E, or at latitude 43° 09′N and longitude 5° 36′E) is capable of promoting the death of Ulva lactuca, without the emission of toxic acidic vapors, such as, e.g., H₂S vapors. Altogether, the inventors provide data showing that this seawater comprises an alive microorganism that is responsible for promoting the death of Ulva, in particular of Ulva lactuca. More precisely, the inventors provide experimental data showing that the microorganism that promotes the death of Ulva lactuca, and hence promotes the control of Ulva lactuca blooms, is a virus.

### FIELD OF INVENTION

The present invention relates to the control of green macroalgae blooms. More particularly, Ulva lactuca green algae blooms may be controlled by an alive microorganism, more specifically a virus, that is contained in seawaters collected from the Mediterranean Sea.

### BACKGROUND OF INVENTION

Microalgae (or seaweeds) are classified into three major groups: brown algae, red algae and green algae, based on their pigmentation. All of these microalgae contain high amounts of carbohydrates (up to 60%), medium/high amounts of proteins (10%-47%) and low amounts of lipids (1%-3%), with a variable content of mineral ash (7%-38%).

With decreasing available land and fresh-water resources, the microalgae become attractive alternatives for the production of valuable biomass, comparable to terrestrial crops. Culture of microalgae under controlled and sustainable cultivation systems is probably a future method of choice for supplying biomass meeting market development needs.

The high carbohydrate fraction includes a large variety of easily-soluble polysaccharides, such as laminarin, alginate, mannitol or fucoidan in brown type algae, starch, mannans and sulfated galactans in red ones and ulvan in green ones. Alginate, one of the main structural polymers of brown seaweeds, provides both stability and flexibility for the specimens exposed to flowing water, and is one of the industrially-relevant carbohydrate compounds found in seaweed biomass, as other hydrocolloids, such as agar-agar and carrageenans, which are commonly used as thickeners, gelling agents or emulsifiers. Various other non-carbohydrate products obtained from seaweeds include proteins, lipids, phenols, terpenoids, and minerals such as iodine, potash and phosphorus, which are ingredients that are useful for both animal and human nutrition.

The interest of microalgae in human nutrition is due to their high mineral concentrations (such as calcium, magnesium and potassium) and glutamic acid, which make them also useful as taste enhancers. Algae could also help to address one of the biggest challenges currently faced by the food industry. Indeed, in contrast to table salt, seaweeds contain lower quantities of sodium and could therefore serve as a substitute to prevent the health risks associated with excessive sodium chloride uptake. Microalgae are also a source of active principles largely explored nowadays for the manufacture of increasing number of pharmaceutical products. The gelling properties of sulfated polysaccharides are well known, and their therapeutic applications are in development. Microalgal polysaccharides, pigments, proteins, amino acids and phenolic compounds are potential functional food ingredients for health maintenance and the prevention of chronic diseases with more and more potential uses in pharmaceutical industries.

Contrarily to microalgae, for which economic interest grows each year, macroalgae remain a hazard, in particular to the sea environment and to human's and animal's health. Indeed, macroalgae blooms damage marine ecosystems and have a negative impact on local tourism. This is notably the case with Ulva lactuca blooms.

Ulva lactuca is a macroalga that belongs to the phylum Chlorophyta, that was first described by Linnaeus in the Baltic Sea in the 18^{th} century. Ulva lactuca alga is made of a bilayer cell structure, and its thallus has generally a flat bladelike appearance. It is able to grow both with a holdfast such as rocks or free floating. Ulva lactuca algae have the capacity to reproduce with two methods, one being sexual and the other being from fragmentation of the thallus, which is rarely observed in macroalgae. These two methods provide a capacity to rapidly proliferate by covering the water surface, hereby decreasing the biodiversity for other algae species. Ulva lactuca is a polymorphic species regarding the degree of water salinity or symbiosis with bacteria.

Ulva lactuca invades principally beaches and its biodegradation can produce toxic acidic vapors (mainly H₂S) that induce death of animals (a horse was reported dead in 2009 on Brittany coasts located at the west of France) due to Ulva lactuca biodegradation and possibly humans.

The first Ulva lactuca bloom to be described was at Belfast (North of Ireland) at the end of the 19^{th} century. Ulva lactuca blooms were well studied in the Laguna of Venice from 1930s with an unexplained decrease observed after 1990s. Since 1980s, Ulva lactuca blooms have been observed worldwide, from Galicia (Spain) to the Tokyo Bay (Japan), including the coasts from the American continent and Australia. However, the largest events in the world to date remain the green tides observed in the Yellow Sea for ten consecutive years from 2007, which covered 10% of its surface. In Europe, Brittany north coasts have the biggest Ulva lactuca blooms. It is nowadays acknowledged that Ulva lactuca blooms are mainly the consequences of human activities, noticeably because of increasing amounts of traces of nitrogen and phosphorus in seawaters. In addition, the green tides observed in seas surrounding Belfast and Venice were correlated with increasing rejection of human wastes.

It was reported that modifying the temperature of the water may influence the proliferation of algae, as in document KR20040037467. Others have also reported that microorganisms, in particular bacteria, may be of use for killing proliferative algae in lakes and rivers (see, e.g., KR20180119021). Finally, JPH1171203 disclosed that (3-cyano-alanine may prove to be efficient, as an algicide, to promote control of blue-green algae in a marine environment.

To date, collection of green algae from seawater or the coastline, e.g., the beach, is the sole solution to cope with Ulva lactuca blooms.

Therefore, there is a need to provide a mean to control and/or eradicate blooms of algae of the genus Ulva, in particular of the species Ulva lactuca, in the seawater or in the land of a coastline contaminated with Ulva.

There is also a need to control Ulva blooms in a safe manner, in particular without emission of toxic acidic vapors, such as, e.g., H₂S vapors.

### SUMMARY

One aspect of the invention relates to a method for controlling and/or preventing blooms of an alga of the genus Ulva in a marine environment in need thereof, comprising the step of contacting said marine environment with seawater collected from the Mediterranean Sea. In certain embodiments, the alga of the genus Ulva is an alga of the species Ulva lactuca. In some embodiments, said seawater is collected at latitude 43° 14′N and longitude 5° 21′E, latitude 43° 09′N and longitude 5° 36′E, latitude 43° 18′N and longitude 5° 17′E, latitude 43° 14′N and longitude 5° 17′E, or at latitude 43° 15′N and longitude 5° 19′E. In one embodiment, said seawater is collected at latitude 43° 14′N and longitude 5° 21′E, or at latitude 43° 09′N and longitude 5° 36′E. In certain embodiments, said seawater comprises an alive microorganism capable of promoting the death of an alga of the genus Ulva. In some embodiments, said alive microorganism is a virus.

In another aspect, the invention also relates to a method for controlling and/or preventing blooms of an alga of the genus Ulva in a marine environment in need thereof, comprising the step of contacting said marine environment with one or more alive microorganism(s) originating from seawater collected in the Mediterranean Sea. In some embodiments, the alga of the genus Ulva is an alga of the species Ulva lactuca. In certain embodiments, said seawater is collected at latitude 43° 14′N and longitude 5° 21′E, latitude 43° 09′N and longitude 5° 36′E, latitude 43° 18′N and longitude 5° 17′E, latitude 43° 14′N and longitude 5° 17′E, or at latitude 43° 15′N and longitude 5° 19′E. In one embodiment, said seawater is collected at latitude 43° 14′N and longitude 5° 21′E, or at latitude 43° 09′N and longitude 5° 36′E. In some embodiments, said alive microorganism is a virus.

Another aspect of the invention pertains to the use of one or more alive microorganism(s) originating from seawater collected in the Mediterranean Sea for controlling and/or preventing blooms of an alga of the genus Ulva in a marine environment. In certain embodiments, the alga of the genus Ulva is an alga of the species Ulva lactuca. In some embodiments, said seawater is collected at latitude 43° 14′N and longitude 5° 21′E, latitude 43° 09′N and longitude 5° 36′E, latitude 43° 18′N and longitude 5° 17′E, latitude 43° 14′N and longitude 5° 17′E, or at latitude 43° 15′N and longitude 5° 19′E. In one embodiment, said seawater is collected at latitude 43° 14′N and longitude 5° 21′E, or at latitude 43° 09′N and longitude 5° 36′E. In certain embodiments, said alive microorganism is a virus.

### Definitions

In the present invention, the following terms have the following meanings:
“About” preceding a figure encompasses plus or minus 10%, or less, of the value of said figure. It is to be understood that the value to which the term “about” refers to is itself also specifically, and preferably, disclosed.
Bloom” refers to a rapid and excessive growth of a population. By extension, “algae bloom” refers to a rapid and excessive growth of algae in a given marine environment. In practice, green algae blooms may be accountable for a “green tide”, which refers to the green coloration of the seawater due the presence of an excessive concentration of green algae in a given perimeter. As used herein, an “algae bloom” is considered as being a pollution matter, because polluted waters, in particular seawaters, and coastline areas, in particular shores and beaches, may become life-threatening to both animal and human, due to the toxic vapors that are emitted upon the degradation of the algae.
“Marine environment” refers to the ecosystem from the seawater, including the open sea (or deep sea), the seashore, the estuaries, the coastline. In practice, the coastline encompasses any land or ground surface in direct contact with the sea, e.g., rocks, beaches.
“Controlling” refers to both the steps, including prophylactic or preventative step, undertaken to prevent or slow down (lessen) a specific deleterious phenomenon. The environments in need of these steps include those already experiencing said specific deleterious phenomenon as well as those prone to experience the specific deleterious phenomenon or those in which the specific deleterious phenomenon is to be prevented. The specific deleterious phenomenon is successfully “controlled” if, after receiving an efficient amount of the seawater collected from the Mediterranean Sea according to the present invention, the environment shows observable and/or measurable reduction in or absence of one or more of the parameters associated with said specific deleterious phenomenon; better quality of the environment. The above parameters for assessing successful control and improvement in the environment are readily measurable by routine procedures familiar to a skilled in the art. In one embodiment, the specific deleterious phenomenon is macroalgae blooms, in particular Ulva lactuca blooms.
“Preventing” refers to keeping from happening, and/or lowering the chance of the occurrence of, at least one parameter of a specific deleterious phenomenon.
“Alive microorganism” refers to a microorganism, e.g., a protozoan, a bacterium or a virus, capable of performing division within suitable conditions. In one embodiment, the alive microorganism is a virus.
“Promoting death” refers to the ability to kill a target. By extension “promoting death of the algae” is intended to refer to the killing or the degradation of the algae. In practice, dead algae are no longer capable of growing, spreading and promoting a green tide. In one embodiment, the death of the algae may be preceded by a whitening, or bleaching, of the tissues of the algae.

As used herein, the expressions “Ulva alga” and “alga of the genus Ulva” are meant to refer to the same subject matter and may substitute to one another.

### DETAILED DESCRIPTION

The inventors observed that major Ulva lactuca blooms, as those observed in the Yellow Sea or in Brittany, do not happen in Mediterranean Sea. However, Ulva lactuca blooms in the Mediterranean Sea should be expected when considering the presence of Ulva lactuca, the absence of significant tides (water stagnation) and the presence of abundant sources of nitrogen and phosphorus. The inventors surprisingly show that controlling Ulva lactuca blooms in Brittany may be feasible by using seawater from one or more selected spots of the Mediterranean Sea. More precisely, the inventors provide herein experimental data showing that the seawater comprise a microorganism that promotes the death of Ulva lactuca, and hence the control of Ulva lactuca blooms, and that this microorganism is a virus.

One aspect of the invention pertains to a method for controlling and/or preventing blooms of an alga of the genus Ulva in a marine environment in need thereof, comprising the step of contacting said marine environment with seawater collected from the Mediterranean Sea.

In another aspect, the invention relates also to the use of seawater collected from the Mediterranean Sea for controlling and/or preventing blooms of an alga of the genus Ulva in a marine environment in need thereof.

Another aspect of the invention pertains to a method for controlling and/or preventing blooms of an alga of the genus Ulva in a marine environment, comprising the step of contacting said marine environment with seawater collected from the Mediterranean Sea.

In another aspect, the invention relates also to the use of seawater collected from the Mediterranean Sea for controlling and/or preventing blooms of an alga of the genus Ulva in a marine environment.

In certain embodiments, an alga of the genus Ulva is selected in the group comprising an alga of the species Ulva acanthophora, Ulva anandii, Ulva arasakii, Ulva armoricana, Ulva atroviridis, Ulva beytensis, Ulva bifrons, Ulva brevistipita, Ulva burmanica, Ulva californica, Ulva chaetomorphoides, Ulva clathrate, Ulva compressa, Ulva conglobata, Ulva cornuta, Ulva covelongensis, Ulva crassa, Ulva crassimembrana, Ulva curvata, Ulva denticulate, Ulva diaphana, Ulva elegans, Ulva enteromorpha, Ulva erecta, Ulva expansa Ulva fasciata, Ulva flexuosa, Ulva geminoidea, Ulva gigantea, Ulva grandis, Ulva hookeriana, Ulva hopkirkii, Ulva howensis, Ulva indica, Ulva intestinalis, Ulva intestinaloides, Ulva javanica, Ulva kylinii, Ulva lactuca, Ulva laetevirens, Ulva laingii, Ulva linearis, Ulva linza, Ulva lippii, Ulva litoralis, Ulva littorea, Ulva lobate, Ulva marginata, Ulva micrococca, Ulva mutabilis, Ulva neapolitana, Ulva nematoidea, Ulva ohnoi, Ulva olivascens, Ulva pacifica, Ulva papenfussii, Ulva parva, Ulva paschima, Ulva patengensis, Ulva percursa, Ulva pertusa, Ulva phyllosa, Ulva polyclada, Ulva popenguinensis, Ulva porrifolia, Ulva procera, Ulva profunda, Ulva prolifera, Ulva pseudocurvata, Ulva pseudolinza, Ulva pulchra, Ulva quilonensis, Ulva radiata, Ulva ralfsii, Ulva ranunculata, Ulva reticulata, Ulva rhacodes, Ulva rigida, Ulva rotundata, Ulva saifullahii, Ulva scandinavica, Ulva serrata, Ulva simplex, Ulva sorensenii, Ulva spinulosa, Ulva stenophylla, Ulva sublittoralis, Ulva subulata, Ulva taeniata, Ulva tanneri, Ulva tenera, Ulva torta, Ulva tuberosa, Ulva uncialis, Ulva uncinate, Ulva uncinate, Ulva usneoides, Ulva utricularis, Ulva utriculosa, Ulva uvoides and Ulva ventricosa.

In some embodiments, the alga of the genus Ulva is selected in a group comprising an alga of the species Ulva armoricana and Ulva lactuca. In one embodiment, the alga of the genus Ulva is an alga of the species Ulva lactuca.

Within the scope of the invention an alga of the species Ulva lactuca may also refer to an Enteromorpha alga.

Within the scope of the instant invention, “a marine environment in need thereof” refers to a seawater ecosystem experiencing or prone to experience Ulva blooms.

In some embodiments, the marine environment may be limited to seawaters, in particular deep sea, seashore, estuaries, and the like.

In practice, assessing whether a marine environment is in need of controlling and/or preventing blooms of an alga of the genus Ulva may be performed by measuring one or more of the following parameters, including the average seawater salinity, the average seawater surface temperature and the average concentration of Ulva in said environment.

Illustratively, measuring the average seawater salinity, i.e. the concentration of salt (in grams) per kg of seawater, may be performed by any method known in the state of the art. Non-limitative examples of methods suitable for measuring seawater salinity includes the measure of electrical conductivity (EC), the measure of total dissolved solids (TDS). In some embodiments, a marine environment in need of controlling and/or preventing blooms of an alga of the genus Ulva may have an average salinity comprised of from about 30 g to about 40 g of salt per kg of seawater. Within the scope of the invention, the expression “from about 30 g to about 40 g of salt per kg of seawater” includes 30 g, 31 g, 32 g, 33 g, 34 g, 35 g, 36 g, 37 g, 38 g, 39 g and 40 g of salt per kg of seawater.

Illustratively, measuring the average seawater surface temperature may be performed by any method known in the state of the art. Non-limitative examples of methods suitable for measuring the average seawater surface temperature includes satellite microwave radiometers, infrared (IR) radiometers, in situ buoys. In some embodiments, a marine environment in need of controlling and/or preventing blooms of an alga of the genus Ulva may have an average surface temperature comprised of from about 12° C. to about 25° C., preferably from about 14° C. to about 20° C. Within the scope of the invention, the expression “from about 12° C. to about 25° C.” includes 12° C., 13° C., 14° C., 15° C., 16° C., 17° C., 18° C., 19° C., 20° C., 21° C., 22° C., 23° C., 24° C. and 25° C.

Illustratively, measuring the average concentration of an alga of the genus Ulva may be performed by any method known in the state of the art. In practice, the biomass of algae in seawater may be assessed by any one of the well-established methods, e.g., methods disclosed in Hambrook Berkman, J. A., and Canova, M. G. (2007, Algal biomass indicators (ver. 1.0): U.S. Geological Survey Techniques of Water-Resources Investigations, book 9, chap. A7, section 7.4). Non-limitative examples of methods suitable for measuring the biomass of algae includes the measure of carbon biomass as ash-free dry mass, the measure of the particulate organic carbon (POC), or the quantification of chlorophyll a in a seawater sample.

In some embodiments, Ulva green algae blooms may be controlled in the seawater, in particular prior to running aground on the coastline, in particular on rocks or on beaches.

In some other embodiments, Ulva green algae blooms may be controlled on the coastline, including any land or ground surface ground surface in direct contact with the sea, e.g., rocks, beaches.

In practice, the seawater according to the invention may be contacted with the alga of the genus Ulva that are lying on the coastline. In some embodiments, Ulva algae are killed prior to its natural biodegradation. In practice, the natural biodegradation is initiated when significant amounts of toxic acidic vapors are emitted, in particular H₂S vapors. Illustratively, once dead, the green algae may be safely removed and/or stored prior to their final destruction.

In certain embodiments, the seawater promotes the death of an alga of the genus Ulva. In some embodiment, the death of an alga of the genus Ulva is achieved without emission of acid vapors, in particular without emission of H₂S vapors.

In some embodiments, said seawater is collected at latitude 43° 14′N and longitude 5° 21′E, latitude 43° 09′N and longitude 5° 36′E, latitude 43° 18′N and longitude 5° 17′E, latitude 43° 14′N and longitude 5° 17′E, or at latitude 43° 15′N and longitude 5° 19′E.

In one embodiment, the seawater is collected at latitude 43° 14′N and longitude 5° 21′E, or at latitude 43° 09′N and longitude 5° 36′E.

In one embodiment, the seawater is collected at latitude 43° 14′N and longitude 5° 21′E.

In one embodiment, the seawater is collected at latitude 43° 09′N and longitude 5° 36′E.

In one embodiment, the seawater is collected at latitude 43° 18′N and longitude 5° 17′E.

In one embodiment, the seawater is collected at latitude 43° 14′N and longitude 5° 17′E.

In one embodiment, the seawater is collected at latitude 43° 15′N and longitude 5° 19′E.

In practice, the seawater may be collected from the surface to a depth of at most 30 m. Within the scope of the instant invention, the expression “at most 30 m” includes 1 cm, 5 cm, 10 cm, 15 cm, 20 cm, 30 cm, 40 cm, 50 cm, 60 cm, 70 cm, 80 cm, 90 cm, 1 m, 1.5 m, 2 m, 2.5 m, 3 m, 3.5 m, 4 m, 4.5 m, 5 m, 5.5 m, 6 m, 6.5 m, 7 m, 7.5 m, 8 m, 9 m, 10 m, 11 m, 12 m, 13 m, 14 m, 15 m, 16 m, 17 m, 18 m, 19 m, 20 m, 21 m, 22 m, 23 m, 24 m, 25 m, 26 m, 27 m, 28 m, 29 m and 30 m.

In certain embodiments, the seawater is collected at a depth comprised of from about 10 cm to about 10 m, preferably from about 50 cm to about 2 m.

In some embodiments, the seawater is collected in the springtime, in particular from March 20 to June 21, more particularly from May 20 to June 20.

In some embodiments, collected samples of seawater are conserved at a temperature of from about 4° C. to about 30° C., preferably from about 10° C. to about 20° C., more preferably of about 20° C. Within the scope of the instant invention, the expression “from about 4° C. to about 30° C.” includes 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C. and 30° C.

In practice, prior to its use to promote the death of an alga of the genus Ulva, the collected samples of seawater may be conserved for at most 50 days, preferably at most 30 days, more preferably at most 10 days. Within the scope of the instant invention, the expression “at most 50 days” encompasses 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2 days and 1 day.

In certain embodiments, said seawater comprises an alive microorganism capable of promoting the death of an alga of the genus Ulva.

In some embodiments, the death of an alga of the genus Ulva may be assessed by the decolorating of the green tissues of algae into white tissues. As used herein, the decolorating of the green tissues of algae into white tissues may also referred to as the “bleaching” of the green tissues of algae. In practice, observation of dead (necrotic) white tissues may be visually assessed or assessed by the mean of optical microscopy. In certain embodiments, white tissues may be observed from about 1 day to about 15 days after contacting the seawater according to the invention with the Ulva algae, preferably at day light and/or at a temperature of from about 20° C. to about 30° C. Within the scope of the instant invention, the expression “from about 1 day to about 15 days” encompasses 1 day, 2, 3, 4, 5, 6, 7, 8, 9, 10, 11, 12, 13, 14 and 15 days. Within the scope of the instant invention, the expression “from about 20° C. to about 30° C.” encompasses 20° C., 21° C., 22° C., 23° C., 24° C., 25° C., 26° C., 27° C., 28° C., 29° C. and 30° C.

In practice, said alive microorganism is selected in a group consisting of protozoa, bacteria and viruses.

In some embodiments, the microorganism according to the invention may be concentrated, isolated and/or characterized.

In some embodiments, the microorganism according to the invention may be purified from the seawater according to the invention. As used herein, the term “purified” refers to the step allowing the isolation of the microorganism according to the invention, as an active principle, from the other alive organisms of the seawater according to the invention. The other alive organisms may include algae, phytoplankton and the like.

Concentration, isolation and characterization of microorganisms may be performed by any suitable techniques from the state in the art.

In some embodiments, the microorganism may be filtered from the collected seawater sample using, e.g., membrane filters, seitz filters, sintered glass filters and/or candle filters. In practice, the filter may have a pore size ranging from about 0.01 μm to about 10 μm. Within the scope of the invention, the expression “from about 0.01 μm to about 10 μm” includes 0.01 μm, 0.02 μm, 0.03 μm, 0.04 μm, 0.05 μm, 0.06 μm, 0.07 μm, 0.08 μm, 0.09 μm, 0.1 μm, 0.2 μm, 0.3 μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm and 10 μm.

In some embodiments, amoebae may be filtered by using a filter with a pore size ranging from about 1 μm to about 10 μm. In some embodiments, bacteria may be filtered by using a filter with a pore size ranging from about 0.05 μm to about 10 μm, preferably from about 0.1 μm to about 8 μm. In some embodiments, viruses may be filtered by using a filter with a pore size ranging from about 0.01 μm to about 1.5 μm, preferably from about 0.1 μm to about 1 μm.

In certain embodiments, the microorganism may be centrifuged by differential centrifugation, optionally after polyethylene glycol (PEG) precipitation. One may refer to the protocols disclosed by Lawrence and Steward (Purification of viruses by centrifugation. 2010; Manual of aquatic viral ecology; Chapter 17, 166-181).

Characterization of microorganisms may be performed by any suitable technique known form the state of the art. Illustratively, Next-generation sequencing (NGS) of the whole genome of the microorganism may be performed after extraction of the nucleic acids from the microorganism. In practice, viral nucleic acids may be extracted using e.g., the QIAamp Viral RNA Mini Kit (QIAGEN®) or the Pure Link® viral RNA/DNA Mini Kit (Invitrogen®). Genomic bacterial nucleic acids may be extracted using e.g., Illustra bacteria genomic Prep Mini Spin Kit (GE Health Life Sciences®) or the NEBNext® Microbiome DNA Enrichment Kit (New England Biolabs®).

In one embodiment, the alive microorganism is a protozoan, in particular an amoeba.

As used herein, the term “protozoa” include marine protozoa, which encompass actinopods, such as radiolarian, heliozoan, acantharean; foraminifera, such as monothalames, polypthalames; amoebae; such as gymnamoebians, thecamoebians. Within the scope of the invention, the expression “marine protozoa” encompasses marine amoebae.

Non-limitative examples of marine amoebae include amoebae of the genus Clydonella; of the genus Lingulamoeba, such as L. leei; of the genus Mayorella, such as M. gemmifera; of the genus Neoparamoeba, such as N. branchiphila; of the genus Vannella, such as V. aberdonica, V. miroides; of the genus Vermistella, such as V. Antarctica; of the genus Vexillifera, such as V. minutissima, V. tasmaniana.

In one embodiment, the alive microorganism is a bacterium, in particular a marine bacterium. Non-limitative examples of marine bacteria include bacteria of the genus Bacillus, such as B. megaterium, B. thuringiensis; of the genus Flavobacterium, such as Formosa agariphila; of the genus Halomonas, such as H. profundus, H. hydrothermalis; of the genus Pseudomonas, such as P. guezennei; of the genus Saccharophagus, such as S. degradans; of the genus Vibrio, such as V. azureus, V. proteolyticus.

In one embodiment, the alive microorganism is a virus. In certain embodiments, the virus belongs to the family of Mimiviridae. In some embodiments, the virus belonging to the family of Mimiviridae is of the genus Cafeteriavirus, of the genus Klosneuvirus, of the genus Mimivirus, of the genus Tupanvirus, and the like. In some embodiments, the microorganism is a virus.

In some embodiments, the virus from the seawater collected from the Mediterranean Sea according to the invention is filtered through a filter of a pore size of about 0.2 μm. In other words, it is understood that the virus passes through a filter of a pore size of about 0.2 μm and that is not retained by said filter.

In certain embodiments, the presence of the virus in the seawater collected from the Mediterranean Sea according to the invention is advantageously stained with aromatic compounds, in particular with SYBR Gold dye (for N′,N′-dimethyl-N-[4-[(E)-(3-methyl-1,3-benzothiazol-2-ylidene)methyl]-1-phenylquinolin-1-ium-2-yl]-N-propylpropane-1,3-diamine) SYBR Gold dye binds preferentially to DNA. This dye is widely used in virology to stain and visualize virus like particles (VLPs) present in seawater and other aquatic samples.

In some embodiments, the amount of the virus in the seawater collected from the Mediterranean Sea according to the invention is ranging from about 10⁵ to about 10⁹ PFU/ml, in particular from about 10⁶ to about 10⁸ PFU/ml.

As used herein, the expression “from about 10⁵ to about 10⁹ PFU/ml” includes 10⁵, 5×10⁵, 10⁶, 5×10⁶, 10⁷, 5×10⁷, 10⁸, 5×10⁸ and 10⁹ PFU/ml.

As used herein, PFU stands for “Plaque Forming Unit”, and refers to the number of viral particles capable of forming plaques in a cell-monolayer.

Another aspect of the invention relates to a method for controlling and/or preventing blooms of an alga of the genus Ulva in a marine environment in need thereof, comprising the step of contacting said marine environment with one or more alive microorganism(s) originating from seawater collected in the Mediterranean Sea.

A further aspect of the invention also pertains to the use of one or more alive microorganism(s) originating from seawater collected in the Mediterranean Sea for controlling and/or preventing blooms of an alga of the genus Ulva in a marine environment in need thereof.

In another aspect, the invention also pertains to the use of one or more alive microorganism(s) originating from seawater collected in the Mediterranean Sea for controlling and/or preventing blooms of an alga of the genus Ulva in a marine environment.

In another aspect, the invention further relates to the use of one or more alive microorganism(s) originating from seawater collected in the Mediterranean Sea in a method for controlling and/or preventing blooms of an alga of the genus Ulva in a marine environment in need thereof.

Another aspect of the invention further relates to the use of one or more alive microorganism(s) originating from seawater collected in the Mediterranean Sea in a method for controlling and/or preventing blooms of an alga of the genus Ulva in a marine environment.

In some embodiments, the effective dose of the virus to control and/or prevent blooms of an alga of the genus Ulva is ranging from about 1×10¹ to about 1×10² PFU/m² of the marine environment to be treated. In certain embodiments, the effective dose ranges from about 1×10² to 1×10⁸, preferably from about 1×10² to about 1×10⁸ PFU/m² of the marine environment to be treated.

Within the scope of the invention, the term “from about 1×10¹ to about 1×10¹² PFU/m² of the marine environment to be treated” includes 1×10¹, 1×10², 1×10³, 1×10⁴, 1×10⁵, 1×10⁶, 1×10⁷, 1×10⁸, 1×10⁹, 1×10¹⁰, 1×10¹¹ and 1×10¹² PFU/m² of the marine environment to be treated.

### BRIEF DESCRIPTION OF THE DRAWINGS

FIGS. 1A-1C are photographs of Enteromorpha algae. FIG. 1A: a green tubular alga formerly called Enteromorpha collected in November 2018 after a bloom in the Trieux fjord (TR) in the north coast of Brittany (48° 46′ N, 3° 06′W). FIG. 1B: the tubular form disappears after an incubation for one month at 20° C. and day light exposure with sea water collected in June 2018 in the bay of Marseille (43° 18′ N 5° 16′E or spot X (RS) in FIG. 2). FIG. 1C: the “Enteromorpha” became a typical Ulva lactuca after three months at 20° C. and day light exposure.

FIG. 2 is a scheme showing a statistical analysis of in vitro Breton Ulva lactuca proliferation with distinct samples of seawater of the bay of Marseille. Seawater samples collected in June 2018 in three different spots in the bay of Marseille. X (RN) was 43° 18′N, 5° 16′E; Y (RS) was 43° 15′N, 5° 19′E and Z (PR) was 43° 14′N, 5° 21′E. Seawater samples were divided in three groups of tubes (n=36). Breton Ulva lactuca collected in June 2018 at Brehec (north coast of Brittany 48° 43′N 2° 06′W) were cut in pieces of 1 cm² and put in the three groups of tubes corresponding to spots X, Y and Z in the bay of Marseille collected one day before sampling (D1). Ulva lactuca proliferation was carried out at 25° C. with seawater in 50 ml tubes closed with a tape to induce anoxia. Proliferation was observed in 25 tubes/36 (69%) in the X spot that corresponds to open sea, while it was 14 tubes/36 (39%) in the Y spots and only 1 tube/36 (2.7%) in the Z spot, the closest of the shore (see the inserted graph). In tubes where Ulva lactuca could proliferate, confluence was reached after one week and acidity was detected. No acidity was observed in tubes where Ulva lactuca could not grow and Ulva lactuca became white after 5 days. Seawater from the Z spot was kept from D30 to D180 before to be incubated again with Breton Ulva lactuca and proliferation was observed in 12 tubes/36 (33%) for D30 and in 36 tubes/36 (100%) for D180 (see the inserted graph).

FIGS. 3A-3D are photographs showing the comparison with optical microscopy of Ulva lactuca in three different states. FIG. 3A: Ulva lactuca became white in five days when incubate at 20° C. and day light exposure with seawater from Z spot of the bay of Marseille. FIG. 3B: Optical microscopy (10×) of white Ulva lactuca. Ulva lactuca tissue remains unaffected with a regular organization of Ulva cells. FIG. 3C: Optical microscopy (10×) of healthy Ulva lactuca. FIG. 3D: Optical microscopy (10×) of Ulva lactuca after acidic biodegradation. Ulva lactuca tissue is disrupted with release of chlorophytes that remain green in spite of anoxia. Photographed with a camera Nikon D3100 coupled to a Nikon Eclipse Ti L100 microscope (Nikon, Tokyo, Japan).

FIGS. 4A-4D are photographs and graph showing the fluorescence microscopy after SYBR staining FIG. 4A-C: sea water from Mediterranean seas inducing bleaching was incubated without Ulva (panel A) and with Ulva (panels B and C). FIG. 4D: shows the virus-like particles amount, expressed as a number of particles/ml. Sea water was filtrated at 0.2 μm.

### EXAMPLES

The present invention is further illustrated by the following examples.

### Example: Identification of Seawater Samples that Promote Death of Ulva lactuca

1) Materials and Methods

a) Ulva lactuca Polymorphism

Green algae were collected in the Trieux fjord in the North coasts of Brittany (48° 46′ N, 3° 06′W). Proliferation was carried out in vitro with seawater samples from the bay of Marseille (Provence, South of France). A green tubular alga formerly called Enteromorpha was collected in November 2018 after a bloom in the Trieux fjord in the north coast of Brittany (48° 46′ N, 3° 06′W). The incubation was carried out for one month at 20° C. and day light exposure with sea water collected in June 2018 in the north bay of Marseille (43° 18′ N 5° 16′E; RN).

b) Ulva lactuca Proliferation

Seawater samples were collected in surface in springtime (June 2018, 2019 and 2020) in eight different spots, including three different spots at Marseille (FIG. 2), 2 spots in Provence, and 3 spots in Brittany (see Table 1). Seawater samples were divided in three groups of tubes (n=36). Breton Ulva lactuca collected in June 2018 at Brehec (north coast of Brittany 48° 43′N 2° 6′O) were cut in pieces of 1 cm² and put in the three groups of falcon tubes (50 ml) corresponding to spots X, Y and Z in the bay of Marseille collected one day before sampling (D1). Acidity was tested with a Crison pH Meter (Barcelona, Catalonia). The pH meter was calibrated before any measurement. Nitrates was measured with a METRHOM chromato ionic device (Berne, Switzerland) with a Metrosep column A supp 5 150/4 mm with 3.2 mM Na₂CO₃/1 mM NaHCO₃ as eluant. Sea Water was diluted ⅛ and a standard was use to calibrate the amount of nitrates.

c) Optical Microscopy

Optical microscopy (10×) was performed on healthy Ulva lactuca before confluence, after acidic biodegradation and on white Ulva lactuca after five days with water sample collected in the Z (PR) spot in the bay of Marseille. Photographs were carried out with a camera Nikon D3100 coupled to a Nikon Eclipse Ti L100 microscope (Nikon, Tokyo, Japan).

d) Diode Array Detection High Performance Liquid Chromatography (DAD HPLC)

Sea water samples were filtered at 0.2 μm and were analyzed on a Beckman HPLC system gold device with a reverse phase (C8) column using H₂O 0.1% TFA (A) and CH₃CN 0.1% TFA (B). The gradient was from 10% to 50% B in 40 min, and then 10 min at 90% B and 10 min at 10% B. Diode Array Detector Beckman device was coupled after the injector. Flow rate was 0.8 ml/min

e) Fluorescence Microscopy after SYBR Staining

Mediterranean seas water without and with Ulva lactuca sample was filtrated through 0.22 μm membrane filter (Millex®; cat. no SLGP033RS) to remove cells and then through 0.02 μm Anodisc filters (Whitman®; cat. no WHA68096002) using a vacuum filtration system to collect viral particles.

Then filters were stained with SYBR Gold dye (N′,N′-dimethyl-N-[4-[(E)-(3-methyl-1,3-benzothiazol-2-ylidene)methyl]-1-phenylquinolin-1-ium-2-yl]-N-propylpropane-1,3-diamine) that binds reverently to DNA (Invitrogen®; cat. no S11494) at room temperature for 15 min in the dark, and washed three times with 500 μL of sterile 0.02 μm-filtered mQ water. Stained virus-like particles were observed with an epifluorescence Microscope Leica SP2.

2) Results

a) Breton Ulva lactuca can Grow in Mediterranean Sea and has Different Phenotypes Regarding Salinity

Ulva lactuca is naturally present in the bay of Marseille (Provence, south of France) and appears each year in winter. Ulva grow rapidly from February to March before disappearing rapidly for springtime. Ulva lactuca blooms, as observed in Brittany, were never reported in the bay of Marseille while this bay has a high concentration in phosphate and nitrogen and shallow beaches. A first hypothesis could be that Breton Ulva lactuca could easily proliferate in Brittany but could not grow in Mediterranean Sea, more particularly, that the nitrate concentration is lower compared to sea water in Brittany. Five spots nearby Marseille were selected and sea water samples were collected and compared to three spots in Brittany (Table 1).

TABLE 1
Springtime Sea Waters (n = 7) from Brittany and Provence

| Location | TR | BR | PO | RN | WF | RS | PR | MU |
|---|---|---|---|---|---|---|---|---|
| Latitude (N) | 48°46′ | 48°43′ | 47°06′ | 43°18′ | 43°14′ | 43°15′ | 43°14′ | 43°09′ |
| Longitude | 3°06′W | 2°56′W | 2°07′W | 5°16′E | 5°17′E | 5°19′E | 5°21′E | 5°36′E |
| Nitrate (μM) | 24 + 583 | 7 + 3 | 11 + 2 | 5 + 2 | 6 + 1 | 5 + 2 | 24 + 5 | 9 + 3 |
| pH | 7.9 | 8.0 | 8.1 | 7.9 | 8.0 | 8.0 | 8.0 | 8.0 |
| Conductimetry | 30.9 | 45.6 | 48.1 | 57.4 | 56.1 | 57.9 | 57.8 | 58.1 |
| (mS) | | | | | | | | |
| Bleaching* | 0 | 0 | 0 | 0 | 0 | 8 | 98 | 85 |
| (%) | | | | | | | | |

*Statistical analysis of in vitro Breton Ulva bleaching with sea water samples collected for springtime. All experiments (n = 8) were carried out with Breton Ulva collected in Trieux fjord (TR) in the north of Brittany in 2018, 2019 and 2020. Ulva were cut in pieces of 1 cm² and put in sea water (40 ml) in tubes (n = 25) closed with a tape and let at day light with an average temperature of 25° C.

The bay of Marseille is at 20 km of the mouth of the Rhone River and North West winds (Mistral and Tramontane) that are dominant blow regularly from Rhone River to Marseille. Table 1 shows that pH and conductimetry (related mainly to salinity) are lower in RN due probably to the influence of Rhone river. Table 1 shows that the concentration in nitrates in open coastal sea water is equivalent in Brittany (BR and PO) and in Provence (RN, WF, RS). However, nitrate concentration can be much higher in Brittany fjord (TR) or in calanque (MU) and marina (PR) in Provence.

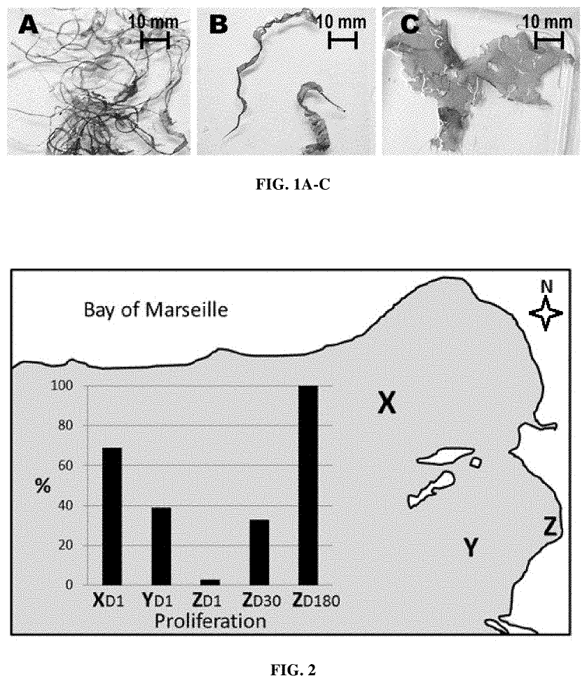

As shown above, Breton Ulva lactuca can grow rapidly with sea waters from Marseille (FIG. 1). Ulva lactuca polymorphism was tested with a green tubular alga formerly called Enteromorpha (FIG. 1A) collected in the Trieux fjord nearby the city of Paimpol (North Brittany) that became a typical Ulva lactuca after three months at 20° C.±10° C. and day light exposure (FIG. 1C). This experiment illustrates the importance of salinity in the polymorphism of Ulva lactuca as previously described (Rybak, Ecological Indicators, 2018, 85, 253-261).

b) Breton Ulva lactuca Proliferation is Different Regarding the Location and the Timing of the Water Sampling in the Bay of Marseille

Natural biodegradation on beaches occurs when Ulva lactuca reach confluence inducing anoxia characterized by production of H₂S. For this biodegradation, Ulva can become white due to dehydration. However, this is a different phenomenon that we observed with Breton Ulva lactuca in sea water collected at Marseille. Breton Ulva lactuca were turning white (bleaching) rapidly sometime in one day without dehydration. To simulate this natural process proliferation of Ulva lactuca was carried out with sea water in 50 ml tubes closed with a tape to induce anoxia.

A statistical analysis was carried out with seawater samples collected in three different spots in Brittany and five spots in Provence, including Marseille bay (Table 1 and FIG. 2). Seawater samples were divided in eight groups of tubes (n=36). Breton Ulva lactuca were cut in pieces of 1 cm² and put in the eight groups of tubes corresponding to spots X (RN), Y (RS) and Z (PR) in the bay of Marseille, PR and MU in Provence, TR and BR (North Brittany) and PO (South Brittany), collected one day before sampling (D1).

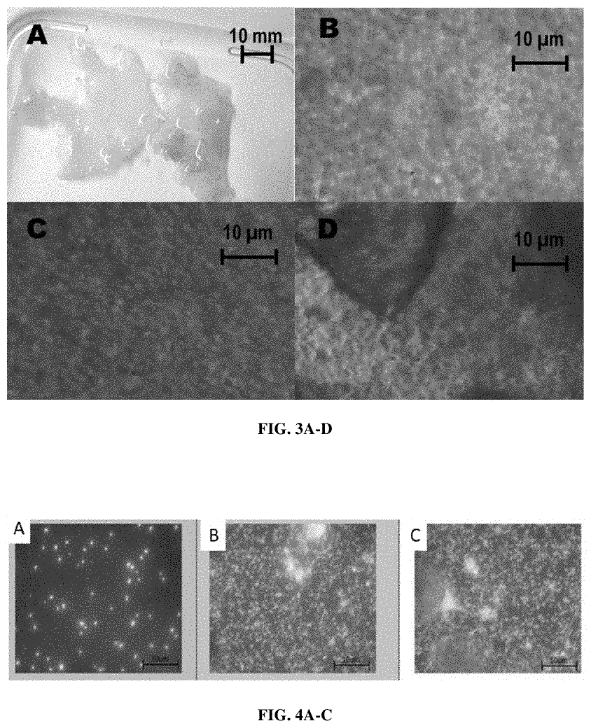

No bleaching was observed with sea water collected in Brittany for springtime when Ulva proliferation is the highest. Regarding the five different spots in Provence, the number of tubes where proliferation could happen was not the same. Proliferation was observed in 25 tubes/36 (69%) for the X spot that corresponds to open sea, while it was 14 tubes/36 for the Y spots and only 1 tube/36 for the Z spot, the closest of the shore. In tubes were Ulva lactuca could not grow, Ulva lactuca were becoming white under day light at 20° C. in five days with no acidity detected, as shown in FIG. 3A. This Ulva lactuca white phenotype was not similar to white dehydrated Ulva lactuca as observed in Brittany, when Ulva lactuca are staying on the shore in low tides. For tubes where Ulva lactuca could proliferate, confluence was reached after one week and acidity was observed according to the regular process of Ulva lactuca biodegradation (Dominguez and Loret, Mar Drugs. 2019 Jun. 14; 17(6). Pii: E357). As observed in natural conditions Ulva lactuca remained green under biodegradation. Sea water from Z spot (FIG. 2) were kept from D30 to D180 before to be incubated again with Breton Ulva lactuca and the proliferation were observed in 12 tubes/36 for D30 and 36 tubes/36 for D180 (FIG. 2). The active principle that promote the death of Breton Ulva lactuca cells is not a pollutant that would have produced the same effect from D1 to D180. Other Breton algae (mainly brown) were not affected with seawaters from Marseille bay (data not shown).

c) Comparison with Optical Microscopy of Ulva lactuca in Three Different States Shows that Tissue is not Disrupted in White Ulva lactuca

What happens in FIG. 3A showing white Ulva lactuca was studied at a tissue level with optical microscopy. FIG. 3B shows that the white tissue of Ulva lactuca remains unaffected with a regular organization of Ulva lactuca cells comparable to healthy Ulva lactuca, which have a thallus composed of tight cells with chlorophytes present in cytoplasm giving a green color to cells (FIG. 3C). The white color in FIG. 3B indicates that cells are dead but this death is not due to a macro predator or environmental conditions that would have disrupted the tissue organization of the alga tissue as shown in FIG. 3C. This is not a sporulation that could provide a white color. The main explanation emerging from these preliminary experiments is that a microorganism specific of Ulva lactuca control Ulva lactuca blooms in the Mediterranean Sea. Only a microorganism attack, in particular a viral attack, could explain this rapid death of Ulva lactuca cells without tissue damage. Furthermore, this hypothesis was confirmed. Indeed, when sea water is filtrated at 0.2 μm, Ulva lactuca can still turn white showing that the bleaching activity is not due to planktons, amoeba or bacteria that have a size superior to 0.2 μm.

d) Diode Array Detection Coupled to High Performance Liquid Chromatography (DAD HPLC)

Mediterranean sea water inducing bleaching was filtrated at 0.2 μm and then analyzed with a DAD HPLC that makes possible to have a UV spectral analyses of each entities eluting at different times from a hydrophobic C8 column with an acetonitrile gradient. Most of the peaks eluting between 5 to 45 min are characterized by a UV spectral signature with a maximum absorption at 243 nm and correspond to organic macromolecules call colloids. The 3D view of the DAD HPLC run shows that colloids are the major components of sea water filtrated at 0.2 μm. Three peaks have a different UV spectral signature. The peak indicated with a red arrow at 3.5 min might correspond to the presence of viral particles and is characterized by a first max. abs. at 266 nm due to nucleic acids and aromatic amino acids. The two other peaks correspond to free nucleic acids at 6 min and free proteins at 45 min characterized respectively by a max. abs. at 260 and 280 nm. When Breton Ulva lactuca are added to Mediterranean seas water for five days and when bleaching occurs, the peak corresponding to virus increases significantly with a maximum absorbance at 266 nm ranging from 7 to 32 mAU. Interestingly, this peak compatible with viral particles increases 78%, while the colloid peaks decrease (due probably to Ulva eating).

e) Virus-Like Particle Stain and Fluorescence Microscopy

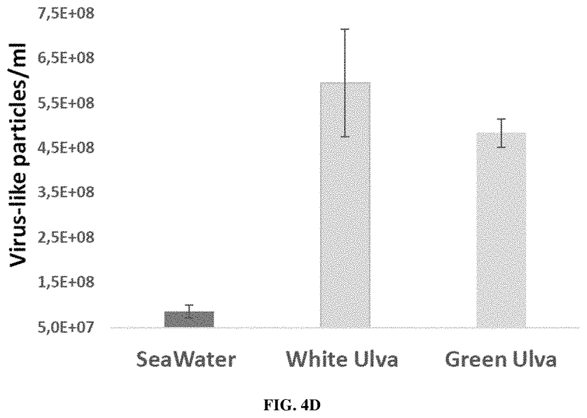

Mediterranean sea water without and with Ulva lactuca was filtrated at 0.2 μm and then stained with an aromatic compounds called SYBR Gold dye (for N′,N′-dimethyl-N-[4-[(E)-(3-methyl-1,3-benzothiazol-2-ylidene)methyl]-1-phenylquinolin-1-ium-2-yl]-N-propylpropane-1,3-diamine) that binds preferentially to DNA. This dye is widely used in virology to stain and visualize virus like particles (VLPs) present in seawater and other aquatic samples. There are hundreds of published reports using this methodology to count and detected viruses in biological samples (Shibata et al., Aquat Microb Ecol. 2006, 43, 223-231). FIG. 4A-C shows that fluorescence microscopy after SYBR staining reveals a high viral production when Ulva lactuca is added to sea water. This high viral production is already significant when Ulva lactuca are still green. However, when Ulva lactuca become white the viral abundance reaches 6.5×10⁸ viruses/ml, which is an atypical viral high concentration (FIG. 4D). This experiment suggests that viruses are actively produced and released with higher rates when Ulva lactuca become bleached.

3) Discussion

The average nitrate concentration in sea water worldwide and in Mediterranean seas is about 1 μM. If nitrate concentration was the reason for the absence of Ulva lactuca proliferation at Marseille, one could have expected nitrate concentration up to 100 μM on Brittany north coast where green tides are the most important in Western Europe particularly for springtime, but such is not the case excepted in river or fjord (Table 1). Nitrate concentrations are variable regarding seasons. In Brittany north coast there is an average of 5 μM at the marine station of Roscoff that went to almost 10 μM in winter to 1 μM in summer in 2018 and 2019 (Service d'Observation en Milieu Littoral (SOMLIT), INSU-CNRS, Roscoff and Marseille” http://somlit-db.epoc.u-bordeauxl.fr/bdd.php). Other parameters such as pH and conductimetry are also variable regarding season at Roscoff (see http://somlit-db.epoc.u-bordeauxl.fr/bdd.php). Data at BR in Briton North coast (Table 1) are in the range of the nitrate concentration observed at Roscoff and a same variability regarding season is observed at Marseille (http://somlit-db.epoc.u-bordeauxl.fr/bdd.php). This variability regarding seasons was also observed in Galicia at the west of Spain (Villares et al., Bol. Inst. Esp. Oceanogr. 1999, 15, 337-341). It is also important to point out that the origin of Ulva green tides does not necessarily come from Brittany coasts. Ulva proliferations are observed in the middle of North Atlantic and Ulva drift to Brittany due to dominant western winds in North Atlantic. Chlorophyll anomalies appear to be more and more frequent in North Atlantic and the main cause of green tides could be due mainly to the global warming. A continuous survey of nitrate concentrations was not performed because the purpose was to compare with the same analytical method and only for springtime if nitrate concentration could be much lower in Marseille compare to Breton north coast to explain the absence of Ulva proliferation. This was found not to be the case and a very interesting survey carried out in Marseille bay in 2007 and 2008 by IFREMER shows that nitrate concentration can be as high in open sea nearby Marseille that it is in North Brittany coast with nitrate concentration superior to 8 μM measured three times in June 2008 (Young et al., PLoS One. 2016, 11(5):e0155152). Furthermore, the chlorophyll activity appears to be abnormally low (0.2 μg/ml) regarding nutriments concentration and can grow up to 1 μg/ml just for very short period that might be explain by viral lyses controlling proliferation (Young et al., PLoS One. 2016, 11(5):e0155152).

Viruses are well known to participate in the control of microalgae bloom but this has so far not been demonstrated for macroalgae. Virus control of microalgae blooms were recently observed in the USA with the two microalgae Aureococcus anophagefferens inducing harmful bloom algae on the east coast (Moniruzzaman et al., Front Microbiol. 2018, 9,752-758) or Tetraselmis in Hawaii (Schvarcz and Steward, Virology 2018, 518,423-433). In the two cases, it was due to viruses recently discovered called giant viruses. Giant viruses were first discovered in amoebae (La Scola et al., Science 2003, 299, 2033-2038). It is interesting to note that moving amoebae were detected in the microscope in FIG. 3B. While most viruses known since one century had size <400 nm, with for instance 160 nm for HIV or 20 nm for the smallest (Parvoviridae infecting pigs), giant viruses have size up to 1 μm. Since then, giant viruses have been discovered all over the world infecting many species, particularly marine species (Abergel et al., FEMS Microbiol Rev 2015, 39, 779-796).

Ulva lactuca blooms will remain a source of troubles that could grow with the global warming. However, there is a natural law hypothesis called “Kill the winner” that may interrupt this Ulva lactuca success story. When there is proliferation of a species, a predator of this species appears to control this proliferation. Among the most powerful natural predators, the biggest is not necessarily the most efficient. The apparition of a predator specific of Ulva lactuca may be a consequence of the high concentration of predators in the Mediterranean Sea, such as viruses, marine bacteria and amoebae. Viruses are the most abundant biological entities in seawaters that can be found even in the bathypelagic (1,000 to 2,000 m) zone and the Mediterranean Sea appears to have the highest concentration mainly in the epipelagic (5 m) zone. If prokaryotes and unicellular algae appear to be the main viral hosts, only 9% of sequences obtained from the viral fraction had an identifiable viral origin and no research was carried out with sequences specific of giant viruses. The predator dynamics can be different regarding temperatures, which could explain why Ulva lactuca disappear in the bay of Marseille for springtime when temperature reach 15° C.

The experiments described for this invention demonstrate that it is possible to control Breton Ulva lactuca proliferation with water samples from Marseille Bay. This control is made by a microscopic living active principle and its concentration is not the same regarding different spots in the bay of Marseille. Of importance, the sample collections in the spring of 3 consecutive years (2018, 2019, 2020) at the same spot (PR) in the bay of Marseille were all able to achieve Ulva lactuca bleaching, indicating that the microorganism, in particular the virus, was persistently retrieved in this marine environment.

1.-16. (canceled)

17. A method for controlling and/or preventing blooms of an alga of the genus Ulva in a marine environment in need thereof, comprising the step of contacting said marine environment with seawater collected from the Mediterranean Sea.

18. The method according to claim 17, wherein said alga of the genus Ulva is an alga of the species Ulva lactuca.

19. The method according to claim 17, wherein said seawater is collected at latitude 43° 14′N and longitude 5° 21′E, latitude 43° 09′N and longitude 5° 36′E, latitude 43° 18′N and longitude 5° 17′E, latitude 43° 14′N and longitude 5° 17′E, or at latitude 43° 15′N and longitude 5° 19′E.

20. The method according to claim 17, wherein said seawater is collected at latitude 43° 14′N and longitude 5° 21′E, or at latitude 43° 09′N and longitude 5° 36′E.

21. The method according to claim 17, wherein said seawater is collected from the surface to a depth of at most 30 m.

22. The method according to claim 17, wherein said seawater is conserved at a temperature of from about 4° C. to about 30° C.

23. The method according to claim 17, wherein said seawater comprises an alive microorganism capable of promoting the death of an alga of the genus Ulva.

24. The method according to claim 23, wherein said alive microorganism is a virus.

25. A method for controlling and/or preventing blooms of an alga of the genus Ulva in a marine environment in need thereof, comprising the step of contacting said marine environment with one or more alive microorganism(s) originating from seawater collected in the Mediterranean Sea.

26. The method according to claim 25, wherein said alga of the genus Ulva is an alga of the species Ulva lactuca.

27. The method according to claim 25, wherein said seawater is collected at latitude 43° 14′N and longitude 5° 21′E, latitude 43° 09′N and longitude 5° 36′E, latitude 43° 18′N and longitude 5° 17′E, latitude 43° 14′N and longitude 5° 17′E, or at latitude 43° 15′N and longitude 5° 19′E.

28. The method according to claim 25, wherein said seawater is collected at latitude 43° 14′N and longitude 5° 21′E, or at latitude 43° 09′N and longitude 5° 36′E.

29. The method according to claim 25, wherein said seawater is collected from the surface to a depth of at most 30 m.

30. The method according to claim 25, wherein said seawater is conserved at a temperature of from about 4° C. to about 30° C.

31. The method according to claim 25, wherein said alive microorganism is a virus.

32. The method according to claim 25, wherein said alive microorganism is purified from said seawater.

33. The method according to claim 25, wherein said alive microorganism is filtered from said seawater.

34. The method according to claim 25, wherein the amount of said alive microorganism is ranging from about 105 to about 109 PFU/mL.
